(19) United States
(12) Patent Application Publication
(10) Pub. No.: US 2006/0031395 A1
(43) Pub. Date: Feb. 9, 2006

(54) Method and system for managing programs for web service system

(75) Inventors: Naotaka Kumagawa, Kawasaki (JP); Satoshi Yamaguchi, Yokohama (JP); Isamu Adachi, Yokohama (JP); Yutaka Nara, Ebina (JP)

Correspondence Address: HOGAN & HARTSON L.L.P., 500 S. GRAND AVENUE, SUITE 1900, LOS ANGELES, CA, 90071-2611, US

(73) Assignee: HITACHI, LTD.

(21) Appl. No.: 11/112,839

(22) Filed: Apr. 21, 2005

(30) Foreign Application Priority Data
Jun. 4, 2004 (JP) 2004-167548

(51) Int. Cl. G06F 15/16

(52) U.S. Cl. 709/217

(57) ABSTRACT

A Web service system includes at least one client terminal that uses a Web service, a server device that provides the Web service, and a UDDI server that manages registered information concerning the Web service in WSDL format in a UDDI registry. The server device provides the client terminal with the Web service through a SOAP message communicated through a connection between the client terminal and the server device. The server device stores information concerning the connection at present in a storage device as current connection information. The client terminal may refer to the current connection information stored in the storage device, and executes a processing concerning the Web service. Also, the server device may store information concerning the connection scheduled to be conducted in the future on the server device in a storage device as scheduled connection information, and the client terminal may refer to the scheduled connection information stored in the storage device, and executes a processing concerning the Web service.

### BACKGROUND OF THE INVENTION

1. Field of the Invention

The present invention relates to Web service providing methods, server devices and client terminals in Web service systems, Web service systems, Web service programs and recording media for storing Web service programs.

2. Description of the Related Art

Many Web services that are Web-based application software in which text search, etc. are made components have been realized due to the spread of the Internet. This technology is described in Java Web Services (2002.3, pp. 3-9) by David A. Cbappell, et al., published by O'Reilly & Associates, Inc. These web services are used through SOAP (Simple Object Access Protocol) messages that are used to call data and services relating to Web services.

Furthermore, client terminals access Universal Description, Discovery and Integration (UDDI) that manages registered information of Web services to know whereabouts of Web services. UDDI manages registered information of Web services, which are described in XML (eXtensible Markup Language)-based WSDL (Web services Description Language) format, as UDDI registry.

Conventional clients that request Web services and servers that provide Web services are not equipped with means that can provide connection information concerning connected servers or clients to their counterparts connected. For this reason, even when servers or clients are to change connection information, their counterparts cannot find the changes promptly.

For example, even when a server is scheduled to be shut down (to turn off the power supply) in ten minutes, a client connected to the server can detect the shut down of the server only after the server has been shut down, and at the time when the shut down is detected. Therefore, the client cannot effectively perform processing to change its connection destination from the server that is shut down to a substitute server.

Since no mechanism is currently available for realizing Web service processings that utilize connection information, the Web service processings are ineffective, which pose a substantial problem.

### SUMMARY OF THE INVENTION

It is a primary object of the present invention to solve the problems described above, and improve the efficiency of Web service processings through the use of connection information.

An embodiment of the present invention pertains to a method for providing a Web service by a Web service system including at least one client terminal that uses the Web service, at least one server device that provides the Web service, and a UDDI server that manages registered information concerning the Web service in WSDL format in a UDDI registry, and the method comprises:
a procedure in which the at least one server device provides the at least one client terminal with the Web service through a SOAP message that is communicated through a connection between the at least one client terminal and the at least one server device;
a procedure in which the at least one server device stores information concerning the connection at present in a storage module as current connection information; and
a procedure in which the at least one client terminal refers to the current connection information stored in the storage module, and executes a processing concerning the Web service.

Other modules, devices and procedures are described in an embodiment described below.

In accordance with the present invention, connection information concerning Web services is registered, and the registered connection information can be used by connection counterparts at any time. As a result, processings relating to Web services can be made more effective by the use of the connection information.

Other features and advantages of the invention will be apparent from the following detailed description, taken in conjunction with the accompanying drawings that illustrate, by way of example, various features of embodiments of the invention.

### BRIEF DESCRIPTION OF THE DRAWINGS

FIG. 1 is a configuration diagram of a Web service system in accordance with an embodiment of the present invention.

FIG. 2A and FIG. 2B are configuration diagrams of a server device and a client terminal in a Web service system in accordance with an embodiment of the present invention, respectively.

FIG. 3A and FIG. 3B are configuration diagrams of a client state management device and a server state management device in accordance with an embodiment of the present invention, respectively.

FIG. 4A and FIG. 4B show examples of messages used in a Web service system in accordance with an embodiment of the present invention.

FIG. 5A and FIG. 5B show examples of tables that manage connection states in a Web service system in accordance with an embodiment of the present invention.

FIG. 6 is a flow chart indicating processings to specify a connection destination by using connection states in a Web service system in accordance with an embodiment of the present invention.

FIG. 7 is a flow chart indicating processings to update connection states, which are initiated from a client terminal in a Web service system in accordance with an embodiment of the present invention.

FIG. 8 is a flow chart indicating processings to update connection states, which are initiated from a server device in a Web service system in accordance with an embodiment of the present invention.

FIG. 9 shows an example of a table for managing connection states in a Web service system in accordance with an embodiment of the present invention.

FIG. 10 shows a diagram for explaining connection states in a Web service system in accordance with an embodiment of the present invention.

### DESCRIPTION OF PREFERRED EMBODIMENTS

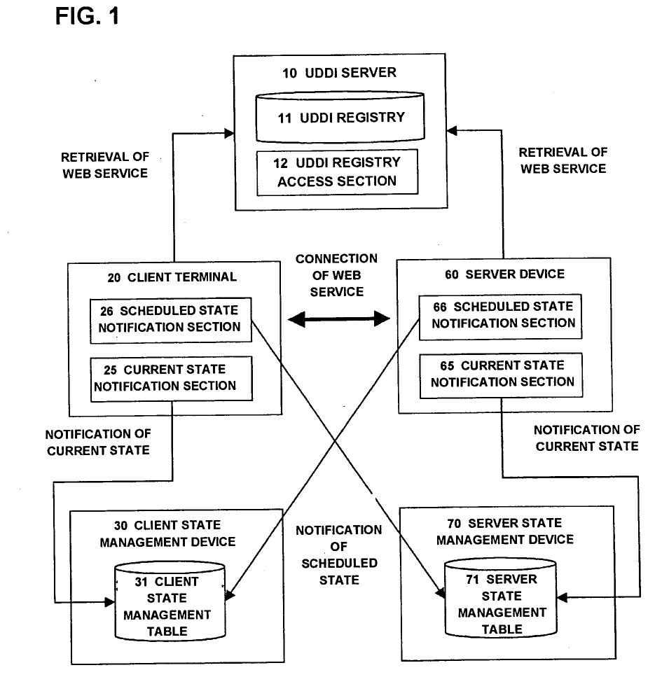

A Web service system in accordance with an embodiment of the present invention is described in detail below with reference to the accompanying drawings. First, a configuration of the Web service system in accordance with the present embodiment is described with reference to FIG. 1 through FIG. 5.

FIG. 1 shows a configuration of the Web service system. The Web service system shown in FIG. 1 has functions to update connection states concerning Web services, and executing the Web services through referring to the connection states. Accordingly, the Web service system is comprised of, at least, a UDDI server 10 that provides search services to search information concerning registered Web services, client terminals 20 that use Web services, and a server device 60 that provides Web services externally through SOAP messages.

The UDDI server 10 includes a UDDI registry 11 that stores registered information of Web services that are provided by the server device 60, and an UDDI registry access section 12 that provides the client terminals 20 with searches for the UDDI registry 11 and provides the server device 60 with updates of the UDDI registry 11. The registered information of Web services are described in, for example, a XML-based WSDL format. In the conventional technology, only specific information (address) of the server device 60 that provides Web services is accepted as the registered information of Web services. However, in accordance with the present embodiment, specific formation (address) of a server state management device 70 of the server device 60 is also accepted, in addition to the specific information (addresses) of the server device 60.

The Web service system includes a client state management device 30 that manages connection states of the client terminal 20 to the server device 60, and a server state management device 70 that manages connection states of the server device 60 to the client terminal 20

Each of the devices (terminals) that compose the Web service system can be implemented by a computer that is equipped at least with a memory (storage device) as a storage region that is used for executing arithmetic processings, and a processor device that executes the aforementioned arithmetic processings. As one of the features of the present embodiment, the Web service system is equipped with a system that manages the connection states.

More specifically, the client terminal 20 notifies the client state management device 30 that manages connection states of the client terminal 20 of its current connection state (by a current state notification section 25), and notifies the server state management device 70 that manages the server device 60 that is a connection counterpart of a scheduled connection state that is scheduled in the future (by a scheduled state notification section 26). Similarly, the server device 60 notifies the server state management device 70 that manages connection states of the server device 60 of its current connection state (by a current state notification section 65), and notifies the client state management device 30 that manages the client terminal 20 that is a connection counterpart of a scheduled connection state that is scheduled in the future (by a scheduled state notification section 66).

The client terminal 20 and the server device 60 can use high quality Web services by referring to these connection states. Hereafter, examples of using the connection states are enumerated.

According to First Example, a client can use connection states of servers for its connection processings. For example, the client terminal 20 decides a server device 60 that is most lightly accessed as a connection destination among a group of server devices 60 that provide a Web service of the same type. More specifically, when the client terminal 20 is to decide a server device 60 that provides a specified service (text search, or the like), the client terminal 20 connects to the server state management device 70 of the server device 60 and obtains the current state of the server device 60, instead of directly connecting to the server device 60. If the connection state of the server device 60 indicates that the server device 60 is accessed by many of the client terminals 20 as connection counterparts, the client terminal 20 excludes the congested server device 60 as a candidate of connection counterpart, because the probability to connect to the server device 60 and its service quality are expected to be deteriorated due to the congestion. In this manner, the client terminal 20 decides a connection counterpart according to the current state acquired from the server state management device 70, such that the probability of successful connections can be improved. Also, to obtain the degree of congestion of each server device, scheduled states can be referred to, instead of current states.

According to another embodiment of First Example, the client terminal 20 decides, among a group of server devices 60 that provide a Web service of the same type, a server device 60 as a connection destination that has a longest period of operating time until the next scheduled stop state (or has no scheduled stop state). As a result, the probability of sustaining the connection of the client terminal 20 and the selected server device 60 for a long term increases.

According to still another embodiment of First Example, when the client terminal 20 attempts to connect to a specified server device 60, the client terminal 20 may refer to parameters of connection information on connections that the specified server device 60 has already established, thereby achieving connection negotiation based on the parameters. As a result, processings required for the negotiation can be eliminated when the specified service device 60 provides the client terminal 20 with connections of the same quality.

According to Second Example, a client can use connection states of servers for Web service usage processings. For example, let us consider the case where the client terminal 20 is connected to two server devices 60 that provide a Web service of the same type. When the client terminal 20 wants to receive the Web service as soon as possible, the client terminal 20 can select a connection with a higher communication quality indicated by connection information of the server devices. When the client terminal 20 treats secret hidden information such as private information, the client terminal 20 may select a connection that achieves a secured communication indicated by connection information of the server devices.

According to Third Example, a client can use connection states of servers for update processings to update connection counterparts. When the client terminal 20 has already established a connection with a specified server device 60, and the specified server device 60 notifies a scheduled state indicating that the connection will be cut in 10 minutes. Then, the client terminal 20 refers to the scheduled state, and attempts to connect to another server 60 (that provides the same Web service) other than the specified server 60. As a result, compared to a system where the client terminal 20 connects to another server 60 after the specified server device 60 has actually cut the connection, the waiting time for switching the connection can be better controlled and/or reduced.

According to Fourth Example, a server can use connection information of clients for connection processings. For example, when a client terminal 20 requests to connect to a server device 60, the server device 60 obtains, from the client state management table 31 (that is stored in the storage device) that manages the client terminal 20 that requested the connection, a scheduled state of connection concerning the client terminal 20. If the scheduled state indicates that the client terminal 20 will “stop connection in ten minutes,” the server device 60 opens (cuts) the connection to the client terminal 20 in ten minutes. In this manner, the server device 60 changes its connection state according to scheduled states of the client terminals 20, thereby more effectively opening its resources. As a result, the Web service can be provided for a large number of client terminals 20.

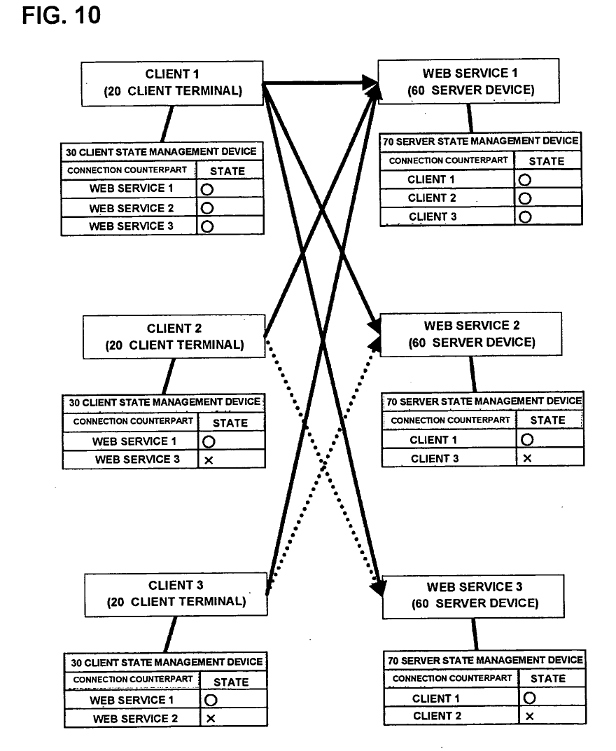

FIG. 10 shows a diagram for describing one example of connection information that is treated by the Web service system of the present embodiment. The Web service system illustrated in FIG. 10 includes three client terminals (i.e., client devices) 20 and three server devices 60. Each of the devices is equipped with a device that manages each corresponding one of the devices, respectively. Each of the client terminals 20 and each of the server devices 60 perform connections concerning Web services. The connections are indicates by arrows, wherein arrows with solid lines indicate connections that can be currently used, and arrows with broken lines indicate connections that cannot be currently used. The client state management device 30 and the server state management device 70 store pairs of connection counterpart and connection state as connection information to be managed, for example. For the connection states shown in FIG. 10, marks “◯” indicate connections that can be currently used, and marks “x” indicate connections that cannot be currently used.

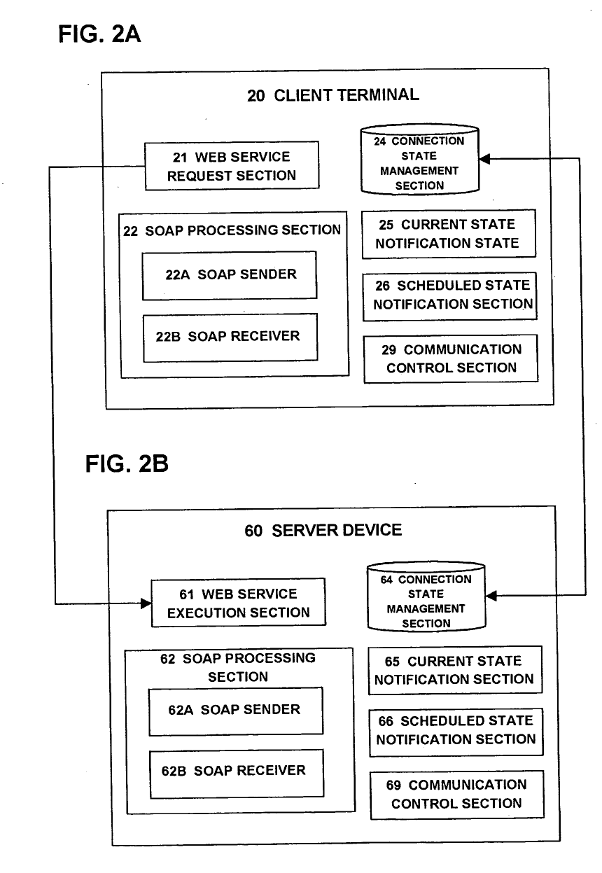

FIG. 2A is a configuration diagram of a client terminal 20 in the Web service system. The client terminal 20 includes a Web service request section 21 that requests Web services that are made components of Web-based application software, a SOAP processing section 22 that processes SOAP messages used to call data and services concerning the Web services, a connection state management section 24 that manages connection states with the server devices, a current state notification section 25 that request to update a current connection state, a scheduled state notification section 26 that requests to update a connection state scheduled in the future, and a communication control section 29 that defines an interface to communicate data with outside devices through a network.

FIG. 2B is a configuration diagram of a server device 60 in the Web service system. The server device 60 includes a Web service execution section 61 that executes Web services, a SOAP processing section 62 that processes SOAP messages used to call data and services concerning the Web services, a connection state management section 64 that manages connection states with the client terminals, a current state notification section 65 that requests to update a current connection, a scheduled state notification section 66 that requests to update a connection scheduled in the future, and a communication control section 69 that defines an interface to communicate data with outside devices through the network.

It is noted that the SOAP processing section 22 of the client terminal 20 may be composed of a SOAP Sender 22A that generates and transmits SOAP messages, and a SOAP receiver 22B that receives and interprets SOAP messages. Also, the SOAP processing section 62 of the server device 60, like the SOAP processing section 22, may be composed of a SOAP sender 62A that generates and transmits SOAP messages, and a SOAP receiver 62B that receives and interprets SOAP messages. Because the client terminal 20 and the server device 60 have their own independent SOAP message generation and interpretation engines, Web services can be called even when the two devices are placed in mutually different environments (for example, on different operating systems).

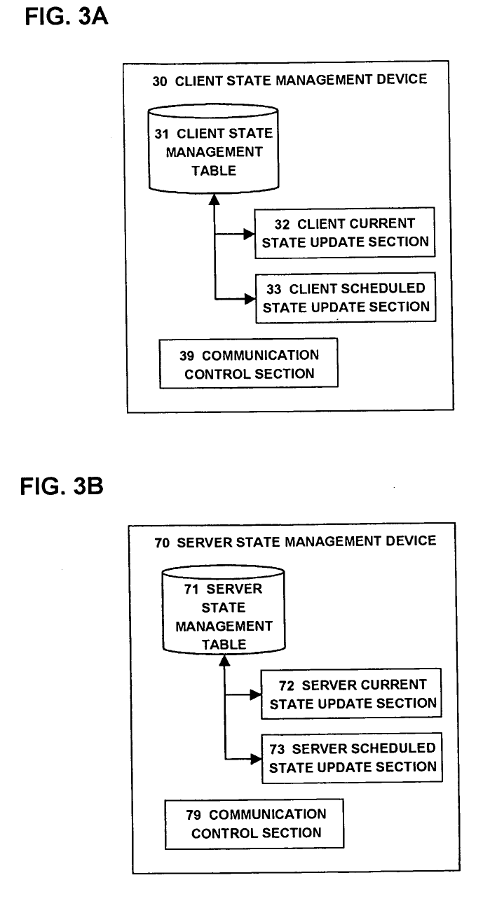

FIG. 3A shows a configuration diagram of a client state management device 30 of the Web service system. The client state management device 30 includes a client state management table 31 that manages connection of the client terminal 20 to the server device 60, a client current state renewal section 32 that updates a current connection state of the client terminal 20, a client scheduled state renewal section 33 that updates a scheduled connection state of the client terminal 20 scheduled in the future, and a communication control section 39 that defines an interface to communicate data with outside devices through a network.

FIG. 3B shows a configuration diagram of a server state management device 70 of the Web service system. The server state management device 70 includes a server state management table 71 (stored in a storage device) that manages connection of the server device 60 to the client terminal 20, a server current state renewal section 72 that updates a current connection state of the server device 60, a server scheduled state renewal section 73 that updates a scheduled connection state of the server device 60 scheduled in the future, and a communication control section 79 that defines an interface to communicate data with outside devices through the network.

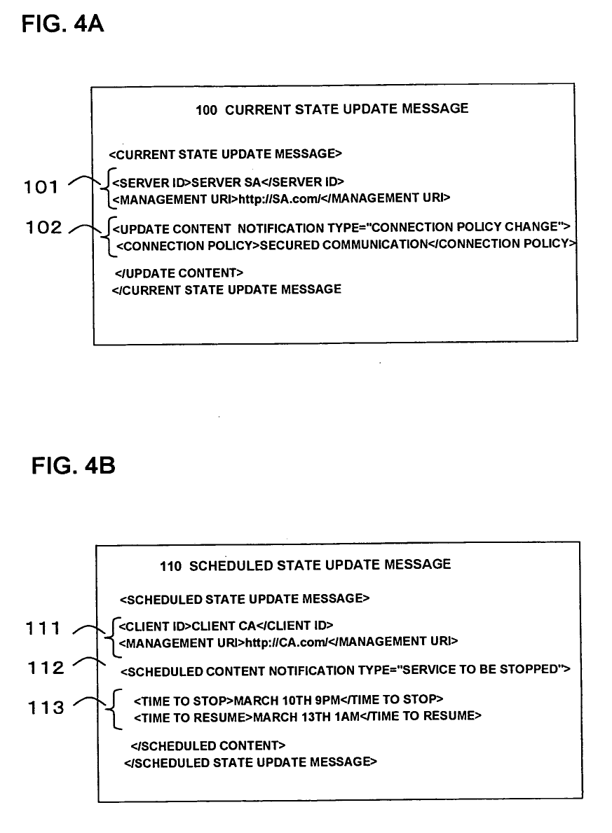

FIG. 4A and FIG. 4B show examples of messages that are used by the Web service system. The examples are in a message format of XML documents. However, a message format can be determined by prior client-server negotiation or de facto standard, and can be in any format if it is mutually analyzable.

FIG. 4A shows an example of a current state update message 100. The current state update message 100 is a message in which each main device notifies a device that manages the main device (for example, the client terminal 20→the client state management device 30, or the server device 60→the server state management device 70) of a current state of the main device. Accordingly, for updating the current state of the server device 60 or the client terminal 20, the current state update message 100 includes a subject device ID 101 (ID of a connection counterpart) that is subject to updating the state and a state content 102 (“state policy change” in this example).

FIG. 4B shows an example of a scheduled state update message 110. The scheduled state update message 100 is a message in which each main device notifies a device that manages a counterpart of the main device (for example, the client terminal 20→the server state management device 70, or the server device 60→the client state management device 70) of a scheduled state of the main device in the future.

Accordingly, for updating a scheduled state in the future of the server device 60 or the client terminal 20, the scheduled state update message 110 includes a subject device ID 111 (ID of a connection counterpart) and a state content 112 (“service stop” in this example), and in addition a scheduled time 113 when the state content is executed.

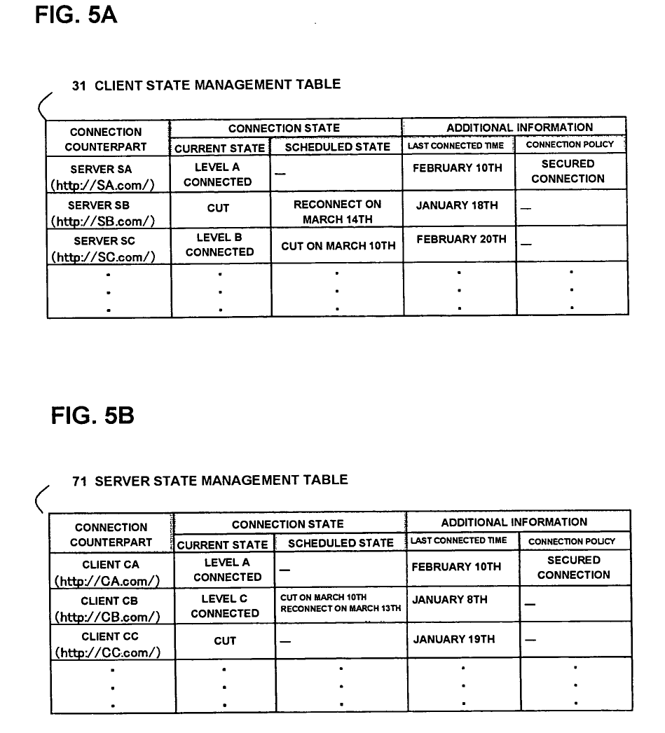

FIG. 5A and FIG. 5B show examples of tables that manage connection states of the Web service system. First, FIG. 5A shows a client state management table 31, and FIG. 5B shows a server state management table 71. The tables shown in FIG. 5A and FIG. 5B are in the same format. In other words, each record entry includes a connection counterpart, a connection state with the connection counterpart, and additional information concerning connection. The connection state is composed of a current state that is updated by the current state update message 100, and a state that is to be updated by the scheduled state update message 110. It is noted that the connection states shown in FIGS. 5A and 5B merely indicate one example of communication parameters, and they are not limited to these illustrated parameters. Other parameters may be communication quality, communication quantity, contract levels, or the like. These connection states may be decided through prior client-server negotiation, de-facto standard or the like.

The current states may include, for example, “Level A connected,” “Level B connected,” “Level C connected,” and “Cut.” The current state of “Level A connected” indicates that a service is provided without fail in the top priority. The current state of “Level B connected” indicates that a service is provided without fail although not in the top priority. The current state of “Level C connected” indicates that there is a possibility that a service may not be provided depending on the condition of the server at the time of a high processing load or the like. The current state of “Cut” indicates that a device is not currently in a state of providing a service. It is noted that a current state of “Stopped” indicating that a server is stopped is one example of the current state.

The connection policy may be “Secure communication” or “None.” The “Secure communication” indicates that SSL (Secure Socket Layer) is used as a connection configuration.

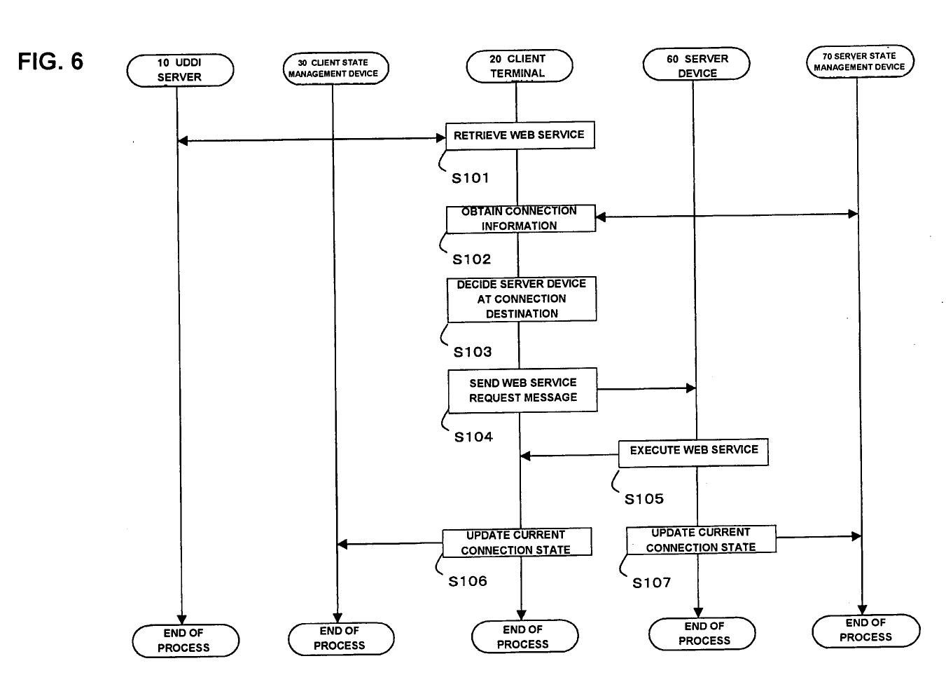

A exemplary configuration of the Web service system in accordance with the present embodiment is described above. Each of the systems, each of the processing sections, each of the devices and each of the servers can be realized by at least one of implementation methods including programs, objects, processes or threads, and may also be realized by hardware. Furthermore, each of the systems, each of the processing sections, each of the devices and each of the servers can be realized by a virtual computer such as a logical server. Next, operations of the Web service system in accordance with the present embodiment are described below with reference to FIG. 6 through FIG. 8.

FIG. 6 shows a flow chart indicating processings that specify a connection destination by using connection states in the Web service system.

First, the client terminal 20 accesses the UDDI server 10 and searches a Web service to be used (S101). It is noted here that the client terminal 20 obtains not only addresses of the server devices 60, but also addresses of the server state management devices 70 that manage the states of the respective server devices 60. Next, the client terminal 20 obtains connection information of the server devices 60 from the server state management devices 70 corresponding to the addresses obtained in step S101 (S102).

Then, the client terminal 20 decides one of the server devices 60 as a connection destination based on the connection information obtained (S103).

The client terminal 20 transmits a request message to request a Web service to the server device 20 at the destination that is decided based on the connection state (S104). Then, upon receiving the request message, the server device 60 executes the Web service for the client terminal 20 (S105).

Further, the client terminal 20 updates the current connection state concerning Web services registered on the client state management device 30 in view of the Web service provided by the server device 60 (S106). The server device 60 also updates the current connection state registered on the server state management device 70 (S107).

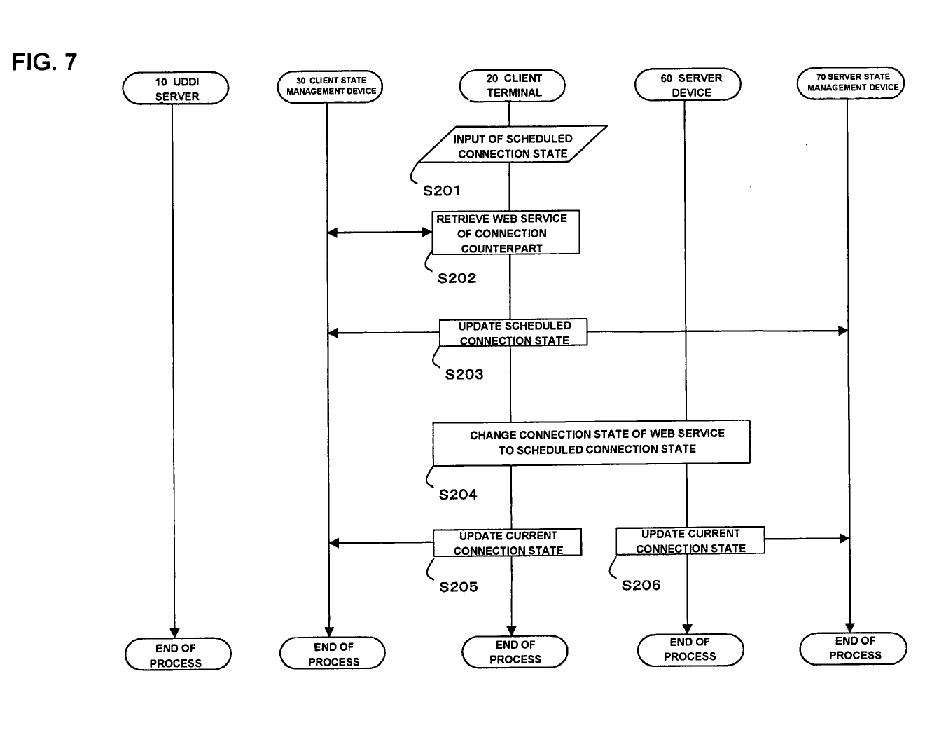

FIG. 7 shows a flow chart indicating processings to update the connection state to be conducted in response to a notification from a client terminal.

First, the client terminal 20 accepts an input of a scheduled connection state (S201). This input can be made from an administrator of the client terminal 20 who plans to cut connections in ten minutes to all of the server devices 60 that are currently connected as a result of the device of the client terminal 20 being transferred elsewhere.

Next, the client terminal 20 searches Web services (server devices 60) of connection counterparts that are subject to the scheduled connection state in step S201 from among the client state management devices 30 (S202). Then, the client terminal 20 sends a request to update the scheduled connection state inputted in step S201 to those of the server state management devices 70 that manage the server devices 60 searched in step S202 (S203).

As the time passes, and when the time comes to execute the scheduled connection state requested in step S203, the client terminal 20 and the server devices 60 update the connection state of the Web service to the scheduled connection state requested in step S203 (S204).

Then, the client terminal 20 updates the current connection state after the update on the client state management device 30 according to the updated connection state executed in step S204 (S205). Further, each of the server devices 60 also updates the current connection state after the update on the server state management device 70 according to the updated connection state executed in step S204 (S206).

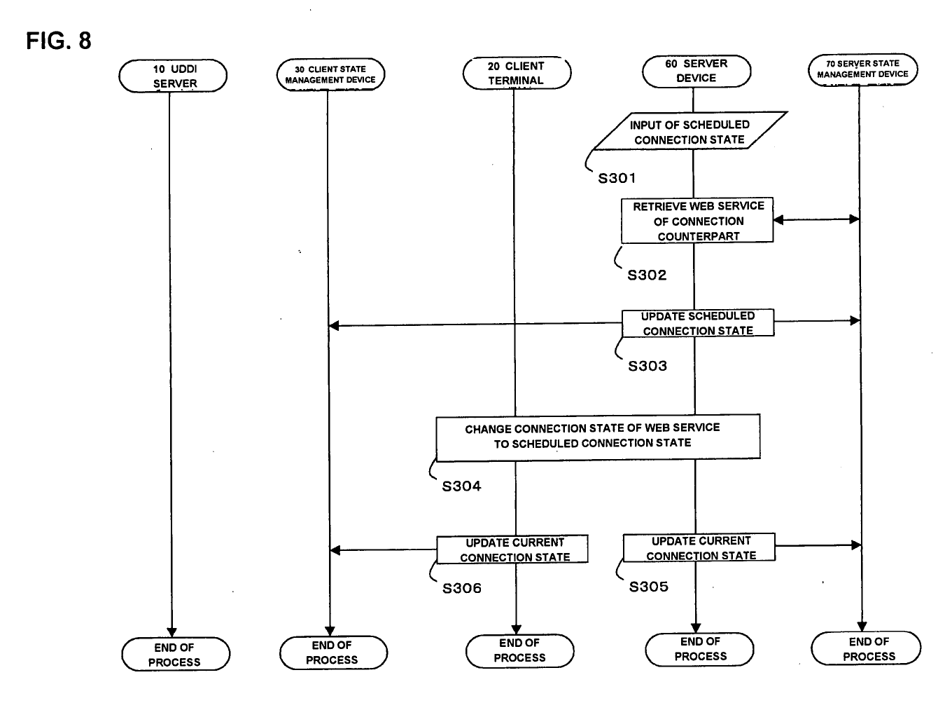

FIG. 8 shows a flow chart indicating processings to update the connection state to be conducted in response to a notification from a server terminal.

First, the server device 60 accepts an input of a scheduled connection state (S301). This input can be made from an administrator of the server device 60 who plans to cut connections in ten minutes to all of the client terminals 20 that are currently connected as a result of the device of the server device 60 being maintained.

Next, the server device 60 searches Web services (client terminals 20) of connection counterparts that are subject to the scheduled connection state in step S301 from among the server state management devices 70 (S302). Then, the server device 60 sends a request to update the scheduled connection state inputted in step S301 to those of the client state management devices 30 that manage the client terminals 20 searched in step S202 (and to the server state management device 70) (S303).

As the time passes, and when the time comes to execute the scheduled connection state requested in step S303, the server device 60 and the client terminals 20 update the connection state of the Web service to the scheduled connection state requested in step S303 (S304).

Then, the server device 60 updates the current connection state after the update on the server state management device 70 according to the updated connection state executed in step S304 (S305). Further, each of the client terminals 20 also updates the current connection state after the update on the client state management devices 30 according to the updated connection state executed in step S304 (S306).

The processings in accordance with the present embodiment described above can be modified and implemented without departing from the scope of the subject matter of the present invention as follows.

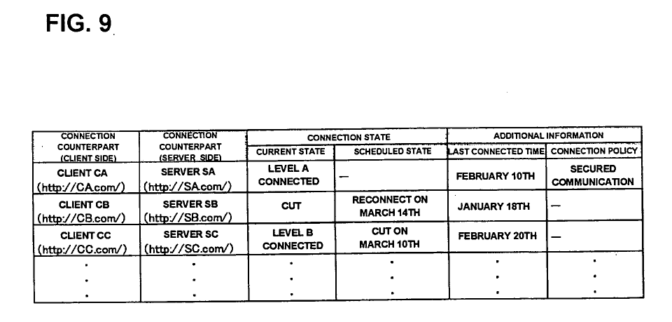

For example, in the embodiment described above, a device that manages and a device that is managed are configured to form a one to one pair. As a result, data to be managed are distributed, such that the influence on a failure of a specified device can be localized. However, instead of the one-to-one configuration, connection states of a plurality of client terminals 20 may be managed. When a plurality of client terminals 20 are to be managed, pairs of client terminals 20 and server devices 60 may be managed as information to specify connections in the client state management table 31, as shown in FIG. 9. Similarly, the server state management device 70 may manage connection states of a plurality of server devices 60 in the server state management table 71 instead of the configuration to manage connection states of one server device 60, as indicated in FIG. 9.

Further, the client state management device 30 and the server state management device 70 may be composed with one device having the functions of the two devices, instead of composing them on individual devices. In this case, the client state management table 31 and the server state management table 71 can be integrated on one table as indicated in FIG. 9, such that hardware resources (used memory amount) can be saved. Further, the step of writing the same connection state conducted twice (S106 and S107, S205 and S206, S305 and S306) can be reduced to one time, such that a shorter processing time can be expected.

Further, in accordance with the present embodiment described above, the client terminal 20 or the server device 60 notifies a scheduled connection state (S203, S303), and then makes a change (updates) the connection state for shifting to the scheduled connection state (S204, S304). In this instance, a message that is created at the time when the scheduled connection state is notified can be used (diverted) for processings to change the connection state for shifting to the scheduled connection state.

While the description above refers to particular embodiments of the present invention, it will be understood that many modifications may be made without departing from the spirit thereof. The accompanying claims are intended to cover such modifications as would fall within the true scope and spirit of the present invention.

The presently disclosed embodiments are therefore to be considered in all respects as illustrative and not restrictive, the scope of the invention being indicated by the appended claims, rather than the foregoing description, and all changes which come within the meaning and range of equivalency of the claims are therefore intended to be embraced therein.

What is claimed is:

1. A method for providing a Web service by a Web service system including at least one client terminal that uses the Web service, at least one server device that provides the Web service, and a UDDI server that manages registered information concerning the Web service in WSDL format in a UDDI registry, the method comprising:
a procedure in which the at least one server device provides the at least one client terminal with the Web service through a SOAP message that is communicated through a connection between the at least one client terminal and the at least one server device;
a procedure in which the at least one server device stores information concerning the connection at present in a storage module as current connection information; and
a procedure in which the at least one client terminal refers to the current connection information stored in the storage module, and executes a processing concerning the Web service.

2. A method for providing a Web service by a Web service system including at least one client terminal that uses the Web service, at least one server device that provides the Web service, and a UDDI server that manages registered information concerning the Web service in WSDL format in a UDDI registry, the method comprising:
a procedure in which the at least one server device provides the at least one client terminal with the Web service through a SOAP message that is communicated through a connection between the at least one client terminal and the at least one server device;
a procedure in which the at least one server device stores information concerning a change in the connection scheduled to take place in the future on the at least one server device in a storage module as scheduled connection information; and
a procedure in which the at least one client terminal refers to the scheduled connection information stored in the storage module, and executes a processing concerning the Web service.

3. A method for providing a Web service by a Web service system including at least one client terminal that uses the Web service, at least one server device that provides the Web service, and a UDDI server that manages registered information concerning the Web service in WSDL format in a UDDI registry, the method comprising:
a procedure in which the at least one server device provides the at least one client terminal with the Web service through a SOAP message that is communicated through a connection between the at least one client terminal and the at least one server device;
a procedure in which the at least one client terminal stores information concerning the connection at present in a storage module as current connection information; and
a procedure in which the at least one server device refers to the current connection information stored in the storage module, and executes a processing concerning the Web service.

4. A method for providing a Web service by a Web service system including at least one client terminal that uses the Web service, at least one server device that provides the Web service, and a UDDI server that manages registered information concerning the Web service in WSDL format in a UDDI registry, the method comprising:
a procedure in which the at least one server device provides the at least one client terminal with the Web service through a SOAP message that is communicated through a connection between the at least one client terminal and the at least one server device;
a procedure in which the at least one client terminal stores information concerning a change in the connection scheduled to take place in the future on the at least one client terminal in a storage module as scheduled connection information; and
a procedure in which the at least one server device refers to the scheduled connection information stored in the storage module, and executes a processing concerning the Web service.

5. A server device that provides a Web service in a Web service system including at least one client terminal that uses the Web service, the server device, and a UDDI server that manages registered information concerning the Web service in WSDL format in a UDDI registry, the server device comprising:
a Web service execution module that provides the at least one client terminal with the Web service through a SOAP message that is communicated through a connection between the at least one client terminal and the server device; and
a state notification module that registers information concerning at least one of the connection at present and a changed in the connection scheduled to take place in the future as connection information.

6. A client terminal that uses a Web service in a Web service system including the client terminal, at least one server device that provides the Web service, and a UDDI server that manages registered information concerning the Web service in WSDL format in a UDDI registry, the client terminal comprising:
a Web service request module that requests the at least one server device for the Web service through a SOAP message that is communicated through a connection between the client terminal and the at least one server device; and
a state notification module that registers information concerning at least one of the connection at present and a change in the connection scheduled to take place in the future as connection information.

7. A state management device in a Web service system including at least one client terminal that uses a Web service, at least one server device that provides the Web service, and a UDDI server that manages registered information concerning the Web service in WSDL format in a UDDI registry, wherein the state management device manages connections between the at least one client terminal and the at least one server device, the state management device comprising:
a state management table that stores information concerning at least one of the connection at present and a change in the connection scheduled to take place in the future as connection information; and
a state update module that update the state management table in response to a notification from one of the at least one client terminal and the at least one server device.

8. A Web service system including at least one client terminal that uses a Web service, at least one server device that provides the Web service, and a UDDI server that manages registered information concerning the Web service in WSDL format in a UDDI registry, the Web service system comprising:
a storage module that stores information concerning the connection between the at least one client terminal and the at least one server device one of at present and scheduled to take place in the future as connection information;
a state update module that updates the connection information stored in the storage module in response to a notification from one of the at least one client terminal and the at least one server device; and
a module that renders one of the at least one client terminal and the at least one server device to execute a process concerning the Web service based on the connection information.

9. A Web service program to be used by a Web service system including at least one client terminal that uses a Web service, at least one server device that provides the Web service, and a UDDI server that manages registered information concerning the Web service in WSDL format in a UDDI registry, the Web service program rendering the Web service system to function as:
a storage module that stores information concerning a connection between the at least one client terminal and the at least one server device at least one of at present and in the future as connection information;
a state update module that updates the connection information stored in the storage module in response to a notification from one of the at least one client terminal and the at least one server device; and
a module that renders one of the at least one client terminal and the at least one server device to execute a process concerning the Web service based on the connection information.

10. A computer-readable storage medium that stores a Web service program to be used by a Web service system including at least one server device that provides a Web service, at least one client terminal that uses the Web service, and a UDDI server that manages registered information concerning the Web service in WSDL format in a UDDI registry, wherein the Web service program renders the Web service system to function as a storage module that stores information concerning a connection between the at least one client terminal and the at least one server device at least one of at present and scheduled to take place in the future as connection information, a state update module that updates the connection information stored in the storage module in response to a notification from one of the at least one client terminal and the at least one server device, and a module that renders one of the at least one client terminal and the at least one server device to execute a process concerning the Web service based on the connection information.

11. A Web service system comprising:
at least one server device that provides Web services;
at least one client terminal that uses the Web services; and
a UDDI server that manages registered information concerning the Web services, wherein
the at least one server device provides the at least one client terminal with the Web services through SOAP messages communicated through a connection between the at least one client terminal and the at least one server device,
the at least one server device stores information concerning the connection at present in a storage module as current connection information, and
the at least one client terminal refers to the current connection information stored in the storage module for executing processings concerning the Web services.

12. A Web service system comprising:
at least one server device that provides Web services;
at least one client terminal that uses the Web services; and
a UDDI server that manages registered information concerning the Web services, wherein
the at least one server device provides the at least one client terminal with the Web services through SOAP messages communicated through a connection between the at least one client terminal and the at least one server device,
the at least one server device stores information concerning a change in the connection scheduled to take place in the future on the at least one server device in a storage module as scheduled connection information, and
the at least one client terminal refers to the scheduled connection information stored in the storage module for executing processings concerning the Web services.

13. A Web service system comprising:
at least one server device that provides Web services:
at least one client terminal that uses the Web services; and
a UDDI server that manages registered information concerning the Web services, wherein
the at least one server device provides the at least one client terminal with the Web services through SOAP messages communicated through a connection between the at least one client terminal and the at least one server device,
the at least one client terminal stores information concerning the connection at present in a storage module as current connection information, and
the at least one server device refers to the current connection information stored in the storage module for executing processings concerning the Web services.

14. A Web service system comprising:
at least one server device that provides Web services;
at least one client terminal that uses the Web services; and
a UDDI server that manages registered information concerning the Web services, wherein
the at least one server device provides the at least one client terminal with the Web services through SOAP messages communicated through a connection between the at least one client terminal and the at least one server device,
the at least one client terminal stores information concerning a change in the connection scheduled to take place in the future on the at least one client terminal in a storage module as scheduled connection information, and
the at least one server device refers to the scheduled connection information stored in the storage module for executing processings concerning the Web services.

15. A method for providing Web services in a Web service system, the Web service system including a plurality of client terminals that use the Web services, a plurality of server devices that provide the Web services, and a UDDI server that manages registered information concerning the Web services, the method comprising the steps of
providing one of the plurality of client terminals with one of the Web services through a SOAP message communicated through a connection between the one of the plurality of client terminals and one of the plurality of server devices; and
registering information concerning at least one of the connection at present and a change in the connection scheduled to take place in the future as connection information.

16. A method for providing Web services in a Web service system, the Web service system including a plurality of client terminals that use the Web services, a plurality of server devices that provide the Web services, and a UDDI server that manages registered information concerning the Web services, the method comprising the steps of:
requesting one of the plurality of server devices to provide one of the Web services through a SOAP message communicated through a connection between one of the plurality of client terminals and the one of the plurality of server devices; and
registering information concerning at least one of the connection at present and a change in the connection scheduled to take place in the future as connection information.

17. A method for providing Web services in a Web service system, the Web service system including a plurality of client terminals that use the Web services, a plurality of server devices that provide the Web services, and a UDDI server that manages registered information concerning the Web services, the method comprising the steps of
storing information concerning at least one of the connection at present and a change in the connection scheduled to take place in the future as connection information; and
updating the connection information in response to a notification from one of the plurality of client terminals and the at least one server device.

18. A method for providing Web services in a Web service system according to claim 16, further comprising the steps of storing the connection information in a state management table, and updating the state management table.

19. A method for providing Web services in a Web service system, the Web service system including a plurality of client terminals that use the Web services, a plurality of server devices that provide the Web services, and a UDDI server that manages registered information concerning the Web services, the method comprising the steps of
storing information concerning connections between the plurality of client terminals and the plurality of server devices as connection information; and
updating the connection information in response to a notification from at least one of the plurality of client terminals and the plurality of server devices.

20. A method according to claim 19, wherein the connection information is indicative of at least one of the connections at present.

21. A method according to claim 19, wherein the connection information is indicative of a change in at least one of the connections scheduled to take place in the future.

22. A method according to claim 19, further comprising the step of rendering at least one of the plurality of client terminals and the plurality of server devices to execute a process concerning the Web services based on the connection information.
